(19) United States
(12) Patent Application Publication
(10) Pub. No.: US 2010/0153448 A1
(43) Pub. Date: Jun. 17, 2010

(54) PERSISTENT SEARCH NOTIFICATION

(75) Inventors: Liam S. Harpur, Skerries (IE); Patrick O'Sullivan, Ballsbridge (IE); Carol S. Zimmet, Boxborough, MA (US)

Correspondence Address: CANTOR COLBURN LLP - IBM LOTUS, 20 Church Street, 22nd Floor, Hartford, CT, 06103, US

(73) Assignee: International Business Machines Corporation, Armonk, NY (US)

(21) Appl. No.: 12/333,539

(22) Filed: Dec. 12, 2008

(51) Int. Cl. G06F 17/30

(52) U.S. Cl. 707/779; 707/E17.017

(57) ABSTRACT

A method for conducting automated persistent searches with notifications includes receiving user inputted topic search criteria; receiving user inputted notification criteria; receiving user inputted search preferences; determining information content sources and collaborative environments to search in response to the user inputted topic search criteria; determining user context information from an event with a defined time of occurrence in response to user input or from a user's calendar and scheduling application; wherein user context information defines a period of relevancy for retrieved information content from a persistent search; performing a persistent search until an exit criteria is met by repeatedly interrogating the determined information content sources and the collaborative environments while taking into account the user's context information; and sending one or more notifications to one or more users upon meeting the exit criteria.

### BACKGROUND

This invention relates generally to information searching technology, and more particularly to a method and system for a persistent search engine that automatically interrogates data sources and notifies one or more users based on the user's context, and position in an ordered taxonomy.

The vast amounts of information contained on the World Wide Web have established the Internet as a preeminent information and research tool. Several types of search engines have been created to assist in the retrieval of information from the Internet. A search engine is an information retrieval system designed to help find information stored on a computer system, such as on the Internet, inside a corporate or proprietary network (known as an Intranet), or in a personal computer. The search engine allows an individual to ask for content meeting specific criteria (typically those containing a given word or phrase) and retrieves a list of items that match those criteria. This list is often sorted with respect to some measure of relevance of the results. Search engines operate algorithmically, or are a combination of algorithmic and human input. Search engines use regularly updated indexes to operate quickly and efficiently. Some search engines also mine or gather data available in newsgroups, databases, or open directories.

Search engines generally employ web crawlers (also known as Web spiders or Web robots/bots) that are programs or automated scripts, which browse networks such as the Internet in a methodical, automated manner as a means of providing up-to-date data. Web crawlers are mainly used to create a copy of all the visited pages for later processing by a search engine, that will index the downloaded pages to provide fast searches. Crawlers may also be used for automating maintenance tasks on a Web site, such as checking links or validating hyper text markup language (HTML) code. Also, crawlers may be used to gather specific types of information from Web pages, such as harvesting e-mail addresses (usually for spam). A web crawler is one type of bot, or software agent. In general, a web crawler starts with a list of Uniform Resource Identifier/locators (URLs) to visit, called the seeds. As the web crawler visits these URLs, it identifies all the hyperlinks in the page and adds them to the list of URLs to visit, called the crawl frontier. URLs from the frontier are recursively visited according to a set of policies.

When a user enters a search phrase of keywords into a search engine there are two factors that determine which Web pages are returned in a list. One factor is the page rank, which is just a measure of goodness or frequency of page views, and has nothing to do with keywords, and the second factor is the weight associated with the keywords for the given page. The keyword weights are adjusted using factors such has how often a keyword appears on a page, the font used to display the keyword and even how close the keyword is to the top of the page. The search engine uses an equation, which involves both the weight of the keywords used in the query along with the page rank for a given page to compute a match score for that page. The web pages are then sorted by their match scores, and the results presented as the search results. One example equation to compute this match score could be:

Match Score=SUM (of matching keyword weights)×page rank.

### SUMMARY

Embodiments of the present invention provide a method for conducting automated persistent searches with notifications, the method includes: receiving user inputted topic search criteria; receiving user inputted notification criteria; receiving user inputted search preferences; determining information content sources and collaborative environments to search in response to the user inputted topic search criteria; determining user context information from an event with a defined time of occurrence in response to user input or from a user's calendar and scheduling application; wherein user context information defines a period of relevancy for retrieved information content from a persistent search; performing a persistent search until an exit criteria is met by repeatedly interrogating the determined information content sources and the collaborative environments while taking into account the user's context information; and sending one or more notifications to one or more users upon meeting the exit criteria.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow chart of a method for a persistent search with notification according to embodiments of the invention.

FIG. 2 is a block diagram illustrating an exemplary system that may be utilized to implement exemplary embodiments of the invention.

FIG. 3 illustrates an example graphical user interface (GUI) for the entry of persistent search and notification parameters according to embodiments of the invention.

The detailed description explains the preferred embodiments of the invention, together with advantages and features, by way of example with reference to the drawings.

### DETAILED DESCRIPTION

Presently available search engines utilized for obtaining content from information sources such as the Internet, messaging environments, and collaborative environments require the user to actively initiate and renew searches until the content the user is searching for is obtained. The present approach to searching is inefficient as the search engine or a searching user themselves repeatedly checks the same information sources for content until the content is obtained.

For example, a development engineer is chairing an event on development techniques in a month's time. In order to prepare for the event, the development engineer searches a developer's blog or wiki for specific development techniques, however the engineer has so far not found any related content results. The engineer routinely wastes time by checking the blog or wiki every day to see if the content they require is eventually posted. Therefore, it would be beneficial for the engineer when they search the development blog or wiki, and the desired content is not there, that they automatically receive notification when their search criteria returns a match prior to the scheduled event. However, there is currently no method or system in place that provides for automatic notification of information availability.

Embodiments of the invention automatically notify a user in the event information matching specified search criteria becomes available or changes from previously searched or consulted information sources. Embodiments of the invention provide ‘persistent’ searches that repeatedly interrogate one or more data sources and notify the user of relevant results, while taking into account the user's context (e.g., an upcoming meeting the user will have, an upcoming conference the user will chair), and based on an ordered taxonomy (classification, specification, order of preferences, distribution ranking, organizational chart, etc.) provides information on a timed or as needed basis.

Embodiments of the invention are configured for users to not only specify a topic search criteria based on topics and keywords, but also search notification criteria, and other search related parameters. In embodiments of the invention a user may specify how, and with what frequency to receive notifications in the event of a search match (or a change in searched match content occurs) becomes available, and under what circumstances the notification is generated. For example, a user may specify under what circumstances to receive instant message (IM) notifications (e.g., when there is greater than an 80% relevancy match to a specified search topic, there is a change in previously searched content, etc.), and the frequency that the IM notification may be sent. In embodiments of the invention, a user may specify under what triggers to initiate a search, and under what triggers to send a notification. Triggers occur as a result of an action. For example, when an application is invoked, the invocation of the application may be an initiator for a search operation.

In embodiments of the invention, search notifications have point-in-time-value based on user context, where the timeliness of provided search information is taken into account relative to an event. Thus prior to an event, information may be relevant, however once the event occurs the information will not be relevant, and a notification will not be made. In other words, content discovery has timed relevancy. Content required before a meeting or event is no longer provided after that event has occurred.

In embodiments of the invention a user may specify search persistence parameters, such as how often to interrogate content for a match, and when the search should expire. For example, notification may be given in the event a match is not made, after a prescribed number of iterations. For example, a blog posting is checked 15 times over a 3-day period. After the third day, a notice may go out to designated recipients about an ‘unsuccess’ record. Optionally at this juncture, a summary report may be captured and presented reflecting the activity that did occur.

Embodiments of the invention may be configured to search information content sources on the Internet, intranets, and collaborative environments. Information sources and collaborative environments may include: Lightweight Directory Access Protocol (LDAP) directories, electronic mail (email) files, wikis, online forums, discussion boards, team rooms, etc.

In embodiments of the invention, search and notification actions may be linked to events and triggers such as for example: calendar, planning, and scheduling application events or entries, ‘To Do’ lists in a calendar, planning, and scheduling applications, application activities (e.g., whenever a certain word processor document is opened), and user activities (e.g., whenever a user is instant messaging a specified individual or group)

In embodiments of the invention, notification provided to recipients may be configured to specify the scope of notification based on an ordered taxonomies such as: recipients in the same department; recipients in the same division; recipients in the same organization; recipients in the same company; recipients in the same location; recipients that the user had previous interactions with in the same networking spaces (e.g. discussion boards, forums, wikis, etc.)

Embodiments of the invention may be configured for a user to set-up a search profile with the following configurable areas: “Basics” (e.g., whether to enable this functionality when a default search is done, etc.); “Scope” (e.g., send search hits to persons in the same division, etc.); “Sources” (e.g., use a particular LDAP directory, discussion boards, mail files, etc.); “Social Networking” (e.g., send search hits to persons that are “close” to the searcher in the “patents” social network, etc.)

In embodiments of the invention, search criteria (specifications and configurations) may be “shared”. For example, a search specification may be transferred to a second user, in the event a first user changes projects, and the second user assumes the first user's responsibilities while also inheriting some of the first user's practices. Sharing, in embodiments of the invention, also refers to modifying a search specification by one or more specified users (authorized authors). For example, authorized authors may be determined by LDAP directory or social network participation. In the event LDAP directory contents are used, authorized authors may be determined by team, project, department, division, geography, organization hierarchy, organization distance, etc.

In embodiments of the invention, search specifications and configurations may be built in a template format, to have content injected at runtime. The template format refers to a general search specification that may be created and applied to one or more search events. Templates provide the user with the ability to specify something once, and have it leveraged again in multiple places. For example, a user would like, for every meeting they hold, that content based on the meeting subject would be searched on in a given location. Furthermore, while each meeting has a different subject, the user requires the search operation to be handled consistently on their behalf.

Embodiments of the invention may be configured with fuzzy logic to provide a set of ‘fuzzy search returns’. Fuzzy search returns refer to instances where sought after information content might also be present in other locations that have not been specified by the user. These other locations may be learned over time, either by self-discovery, monitoring the originating user's actions, or collecting from other sources (LDAP Directory set or social networked). For example, a user is looking for information about test practices to be posted to a given blog, and there have been other blogs they have reviewed at other previous times. The locations of the other blogs are known in memory cache or recorded elsewhere, and search process, of embodiments of the invention, when not actively meeting the request as exactly specified, could be searching in the alternate locations for near matches.

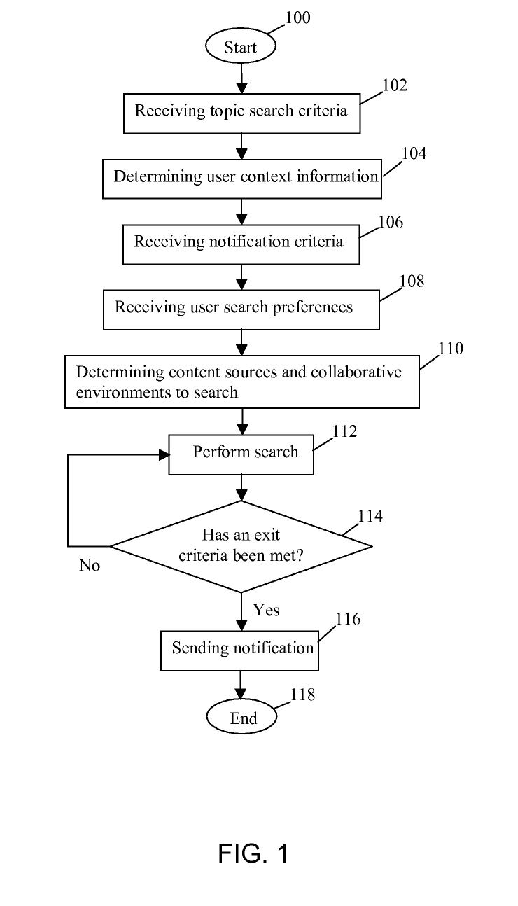

FIG. 1 is a flow chart of a method for a persistent search with notification according to embodiments of the invention. The process starts (block 100) by receiving inputted topic search criteria from one or more users (block 102), determination of the context of the one or more users (block 104), receiving inputted notification criteria of the one or more users (block 106), and receiving inputted search preferences for the one or more users (block 108). Subsequently, in response to the received topic search criteria, a determination of which content sources and collaborative environments to search is made (block 110), and a search is performed (block 112) until a determination of whether an exit criteria has been met (decision block 114). Exit criteria are based on the received context information, notification criteria, and search preferences. Examples of exit criteria include, but are not limited to, search execution frequency, exit if match found, exit if additional content found in search (new content matches), associated event has occurred (trigger), fuzzy match(es) have provided sufficient results, number of search passes have been exceeded, etc. In the event the exit criteria have not been met (decision block 114 is No), the persistent search continues (block 112). In the event the exit criteria have been met (decision block 114 is Yes), the one or more users are sent notification (block 116) according to the received notification criteria, and the process concludes (block 118).

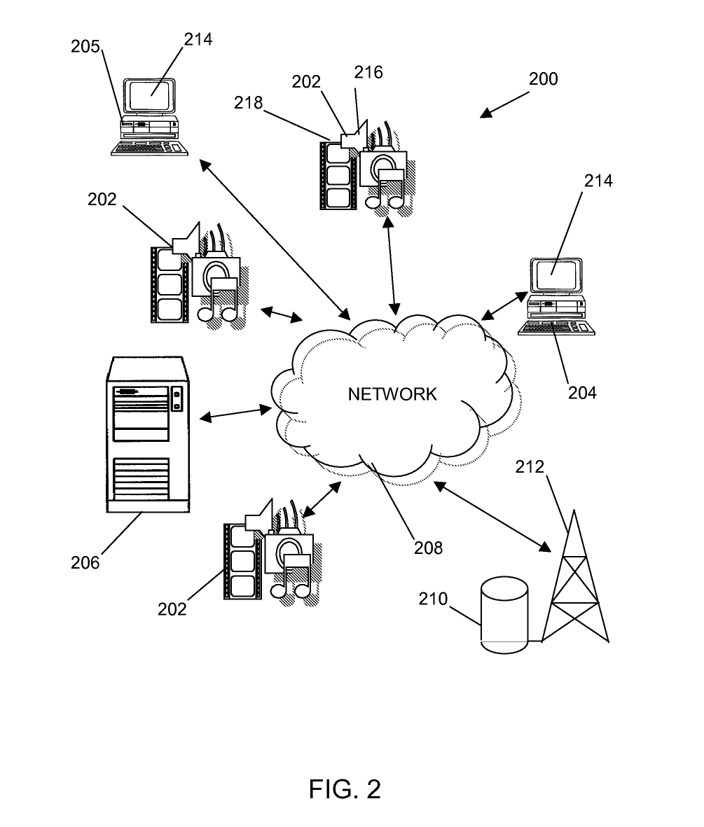

FIG. 2 is a block diagram illustrating an exemplary system that may be utilized to implement exemplary embodiments of the invention. The system 200 includes remote devices in the form of client devices including one or more multimedia/communication devices 202 equipped with speakers 216 for implementing audio, as well as display capabilities 218 for facilitating graphical user interface (GUI) aspects of the present invention, including the display for configuration of persistent search and notification parameters. In addition, client devices include mobile computing devices 204 and desktop computing devices 205 equipped with displays 214 for use with the GUI of the present invention are also illustrated. The remote devices 202 and 204 may be wirelessly connected to a network 208. The network 208 may be any type of known network including a local area network (LAN), wide area network (WAN), global network (e.g., Internet), intranet, etc. with data/Internet capabilities as represented by server 206. Communication aspects of the network are represented by cellular base station 210 and antenna 212. Each remote device 202 and 204 may be implemented using a general-purpose computer executing computer programs. The persistent search software may be resident on a storage medium local to the remote devices 202 and 204, or maybe stored on the server system 206 or cellular base station 210. The server system 206 may belong to a public service. The remote devices 202 and 204 and desktop device 205 may be coupled to the server system 206 through multiple networks (e.g., intranet and Internet) so that not all remote devices 202, 204, and desktop device 205 are coupled to the server system 206 via the same network. The remote devices 202, 204, desktop device 205, and the server system 206 may be connected to the network 208 in a wireless fashion, and network 208 may be a wireless network. In a preferred embodiment, the network 208 is a LAN and each remote device 202, 204 and desktop device 205 executes a user interface application (e.g., web browser) to contact the server system 206 through the network 208. Alternatively, the remote devices 202 and 204 may be implemented using a device programmed primarily for accessing network 208 such as a remote client.

Embodiments of the invention may be implemented in a client-based architecture, where a search request specification is created and stored on a user's local client system. Background agents, also referred to as background tasks, may be executing on a regular basis in the background on the local client system to detect if there's any activity or trigger based search requests to act upon, and executes a search if an activity or trigger is found. For example, when a calendar entry is about to occur, and the user has specified that they want a five minute notification, a background agent or task that is running regularly and looking for upcoming requests for action, acts upon the five minute notification when the time criteria has been met. Search results found (either by a search criteria match or by a discontinue notification) may integrate in a local client system interface, such as for email, IM, etc., based on a user's preferences. Discontinue notifications alert the user(s) when a persistent search effort has ceased due to expiration of time or relevancy, or in the event a successful search match has been found.

In addition, embodiments of the invention may be implemented in a server-based architecture, where user specifications are stored on a central server. In a server-based embodiment of the invention, server tasks are executed on a regular basis within the central server to detect the presence of activity based search requests to act upon, and execute activity based search requests if an activity based search request is detected. Search results found (either by match or by a discontinue notification) may be integrate in the local system interfaces for email, IM (instant messaging), etc., based on user preferences.

Client based architectures, of embodiments of the invention, are generally configured to support a single user request queue. However, in the event a client system is shared between multiple users, multiple user requests are stored locally and processed by the background agent.

Server based architectures, of embodiments of the invention, are configured to best support one or more users simultaneously. The server-based architecture may be configured so that search requests for information and handling may be stored in an accessible database. Server based tasks regularly execute and check for user requests that require servicing. Search results and notifications may be returned to appropriate users based on specified user preferences. In the event a request's relevancy has expired (for example if the associated event has occurred and the associated information is no longer required), a relevancy decision response (notification) may be returned to the user and the database request entry is appropriately updated (eliminated). In embodiments of the invention, additional opportunities are presented when dealing with multiple users request management, such as prioritization of incoming requests, administration management of content, access rights to the request specifications or results returned, etc.

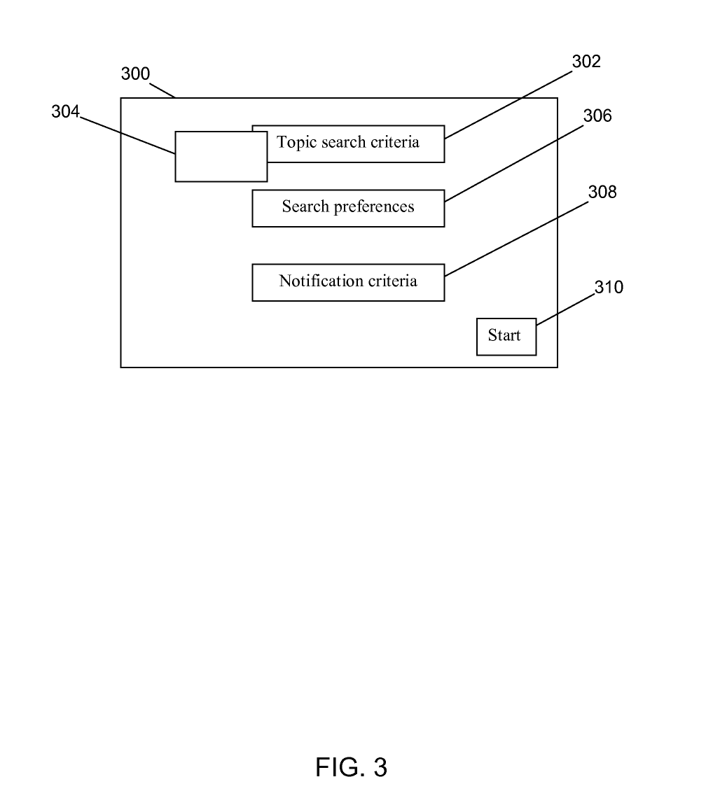

FIG. 3 illustrates an example graphical user interface (GUI) 300 for the entry of persistent search and notification parameters according to embodiments of the invention. The GUI 300 has data entry fields (302, 304, 306), which may be in the form of pull down menus 304, for the entry of topic search criteria 302, search preferences 306, and notification criteria 308. A start button 310 is clicked on by a user to initiate a search.

The capabilities of the present invention can be implemented in software, firmware, hardware or some combination thereof

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

1. A method for conducting automated persistent searches with notifications, the method comprising:
receiving user inputted topic search criteria;
receiving user inputted notification criteria;
receiving user inputted search preferences;
determining information content sources and collaborative environments to search in response to the user inputted topic search criteria;
determining user context information from an event with a defined time of occurrence in response to user input or from a user's calendar and scheduling application;
wherein user context information defines a period of relevancy for retrieved information content from a persistent search;
performing a persistent search until an exit criteria is met by repeatedly interrogating the determined information content sources and the collaborative environments while taking into account the user's context information; and
sending one or more notifications to one or more users upon meeting the exit criteria.

2. The method of claim 1, wherein the received user notification criteria further comprise: specifying how, and with what frequency to receive notifications in the event of a search match, whether to notify the user in the event of a change in searched match content, and which users to notify based on an ordered taxonomy.

3. The method of claim 1, wherein the persistent search is performed in response to a triggering event, comprising one or more of:
calendar, planning, and scheduling application events or entries, ‘To Do’ lists in a calendar, planning, and scheduling applications, application activities, and user activities.

4. The method of claim 1, wherein search criteria are shared between users.

5. The method of claim 1, wherein search criteria are built in a template format.

6. The method of claim 1, wherein the determining of information content sources and collaborative environments to search is based on fuzzy logic.

7. The method of claim 1, wherein the exit criteria are based on the determined context information, notification criteria, and search preferences.
